(19) United States
(12) Patent Application Publication
(10) Pub. No.: US 2008/0231566 A1
(43) Pub. Date: Sep. 25, 2008

(54) MINIMIZING DARK CURRENT IN OLED DISPLAY USING MODIFIED GAMMA NETWORK

(75) Inventor: Walter Edward Naugler, Katy, TX (US)

Correspondence Address: FENWICK & WEST LLP, SILICON VALLEY CENTER, 801 CALIFORNIA STREET, MOUNTAIN VIEW, CA, 94041, US

(73) Assignee: LEADIS TECHNOLOGY, INC., Sunnyvale, CA (US)

(21) Appl. No.: 12/033,527

(22) Filed: Feb. 19, 2008

Related U.S. Application Data
(60) Provisional application No. 60/919,199, filed on Mar. 20, 2007.

(51) Int. Cl. G09G 3/32

(52) U.S. Cl. 345/82

(57) ABSTRACT

The current drivers of an emissive display device such as an OLED display are shut off to have minimum drain current when sub-pixel current is measured, in order to minimize dark current during sub-pixel current measurement. The current drivers in the sub-pixels not under test are biased in such a manner as to reduce their leakage current to a minimum. Therfore, the signal to noise ratio between the OLED sub-pixel current and the panel dark current can be maximized.

### CROSS-RERENCE TO RELATED APPLICATION

This application claims priority under 35 U.S.C. §119(e) from co-pending U.S. Provisional Patent Application No. 60/919,199 entitled “Method for Accurately Measuring the Current Through One Pixel in an Active Matrix Emissive Display,” filed on Mar. 20, 2007, which is incorporated by reference herein in its entirety.

### BACKGROUND OF THE INVENTION

1. Field of the Invention

The present invention relates to measuring sub-pixel current in an active matrix emissive display.

2. Description of the Related Arts

An OLED display is generally comprised of an array of organic light emitting diodes (OLEDs) that have carbon-based films disposed between two charged electrodes. Generally one electrode is comprised of a transparent conductor, for example, indium tin oxide (ITO). Generally, the organic material films are comprised of a hole-injection layer, a hole-transport layer, an emissive layer and an electron-transport layer. When voltage is applied to the OLED, the injected positive and negative charges recombine in the emissive layer and transduce electrical energy to light energy. Unlike liquid crystal displays (LCDs) that require backlighting, OLED displays are self-emissive devices—they emit light rather than modulate transmitted or reflected light. Accordingly, OLEDs are brighter, thinner, faster and lighter than LCDs, and use less power, offer higher contrast and are cheaper to manufacture.

An OLED display typically includes a plurality of OLEDs arranged in a matrix form including a plurality of rows and a plurality of columns, with the intersection of each row and each column forming a pixel of the OLED display. An OLED display is generally activated by way of a current driving method that relies on either a passive-matrix (PM) scheme or an active-matrix (AM) scheme.

In a passive matrix OLED display, a matrix of electrically-conducting rows and columns forms a two-dimensional array of picture elements called pixels. Sandwiched between the orthogonal column and row lines are thin films of organic material of the OLEDs that are activated to emit light when current is applied to the designated row and column lines. The brightness of each pixel is proportional to the amount of current applied to the OLED of the pixel. While PM OLEDs are fairly simple structures to design and fabricate, they demand relatively expensive, current-sourced drive electronics to operate effectively and are limited as to the number of lines because only one line can be on at a time and therefore the PM OLED must have instantaneous brightness equal to the desired average brightness times the number of lines. Thus, PM OLED displays are typically limited to under 100 lines. In addition, their power consumption is significantly higher than that required by an active-matrix OLED. PM OLED displays are most practical in alpha-numeric displays rather than higher resolution graphic displays.

An active-matrix OLED (AMOLED) display is comprised of OLED pixels that have been deposited or integrated onto a thin film transistor (TFT) array to form a matrix of pixels that emit light upon electrical activation. In contrast to a PM OLED display, where electricity is distributed row by row, the active-matrix TFT backplane acts as an array of switches coupled with sample and hold circuitry that control and hold the amount of current flowing through each individual OLED pixel during the total frame time. The active matrix TFT array continuously controls the current that flows to the OLEDs in the each of pixels, signaling to each OLED how brightly to illuminate.

FIG. 1 illustrates a conventional active matrix OLED display. While the example of FIG. 1 is illustrated as an OLED display, other emissive-type displays would have structures similar to that illustrated in FIG. 1. Referring to FIG. 1, the OLED display panel includes a plurality of rows Row 1, Row 2, . . . , Row Y and a plurality of columns Col. 1, Col. 2, . . . , Col. X arranged in a matrix. The intersection of each row and each column forms a pixel of the OLED display. The OLED display also includes a Gamma network 104, row drivers 116-1, 116-2, . . . , 116-y, column drivers 114-1, 114-2, . . . , 114-x, and a timing controller 112.

For a color OLED display, each pixel includes 3 sub-pixels that have identical structure but emit different colors (R, G, B). For simplicity of illustration, FIG. 1 illustrates only one sub-pixel (denoted as dashed line boxes in FIG. 1, such as box 120) corresponding to one of the R, G, B colors per pixel at the intersection of each row and each column. However, in real OLED display panels, each pixel includes three identical ones of the sub-pixel structure 120 as illustrated in FIG. 1. As shown in FIG. 1, the active drive circuitry of each sub-pixel 120 includes TFTs T1 and T2 and a storage capacitor Cs for driving the OLED D1 of the sub-pixel 120. In the following explanation of FIG. 1, the type of the TFTs T1 and T2 is an n-channel TFT. However, note that p-channel TFTs may also be utilized in the active matrix.

Image data 110 includes data indicating which sub-pixel 120 of the OLED display should be turned on and the brightness of each sub-pixel. Image data 110 is sent by an image rendering device (e.g., graphics controller (not shown herein)) to the timing controller 112, which coordinates column and row timing. The timing controller 112 sends digital numbers (DN) 101 indicating pixel brightness to the gamma network 104. Row timing data 105 included in image data 110 is coupled to the gate lines 150 of each row through its corresponding row driver 116-1, 116-2, . . . , 116-y. Row drivers 116-1, 116-2, . . . , 116-y drive the gate line 150 so that the gate lines 150 carry an over-voltage of 25 to 30 volts when active. The gates of TFTs T2 of each sub-pixel in a row are connected to gate line 150 of each row to enable TFTs T2 to operate as switches. The data lines 160 are connected to the drains of TFTs T2 in each column. When the gate line 150 becomes active for a row based on the row timing data 105, all the TFTs T2 in the row are turned on. Timing controller 112 sends column timing data 106 to the column drivers 114-1, 114-2, . . . , 114-x. The Gamma network 104 generates the T1 gate voltages 102 (brightness) to be applied to each TFT T1 in the row when the sub-pixel 120 is turned on, based on digital numbers (DNs) 101 corresponding to each gate voltage 102. Column drivers 114-1, 114-2, . . . , 114-x provides analog voltages 160 to be applied to the gates of TFTs T1, corresponding to the T1 gate voltages 102. The voltages 102 representing pixel brightness values are distributed from the Gamma network 104 to all the column drivers 114-1, 114-2, . . . , 114-x in parallel after the appropriate T1 gate voltages 102 have been sent from gamma network 104 to each column driver 114-1, 114-2, . . . , 114-x under control of the column timing data 106 from timing controller 112. Under control of the timing controller 112, for example, row driver 1 (116-1) is activated and all the voltages 102 placed on the column drivers 114-1, 114-2, . . . , 114-x are downloaded to the TFT T1s in row 1. Timing controller 112 then proceeds to send brightness data for the next row (e.g., row 2) using the row driver 2 (116-2) to column drivers 114-1 through 114-x and activating row 2 and so forth, until all rows have been activated and brightness data for the total frame has been downloaded and all the sub-pixels are turned on to the brightness indicated by the image data 110.

The source of TFT T2 is connected to the gate of TFT T1 and to one side of storage capacitor Cs. The drain of TFT T1 is connected to positive supply voltage VDD. The other side of storage capacitor Cs is also connected, for example, to the positive supply voltage VDD and to the drain of TFT T1. Note that the storage capacitor Cs may be tied to any reference electrode in the pixel. The source of TFT T1 is connected to the anode of OLED D1. The cathode of OLED D1 is connected to negative supply voltage Vss or common Ground. The analog voltages 160 are downloaded to the OLED display a row at a time.

When TFT T2 is turned on, the analog T1 gate voltage 160 is applied to the gate of each TFT T1 of each sub-pixel 120, which is locked by storage capacitor Cs. When the row scan moves to the next row, the gate voltage of TFT T1 is locked for the frame time until the next gate voltage for that sub-pixel is sent by the column drivers 114-1, 114-2, . . . , 114-n. In other words, the continuous current flow to the OLEDs is controlled by the two TFTs T1, T2 of each sub-pixel. TFT T2 is used to start and stop the charging of storage capacitor Cs, which provides a voltage source to the gate of TFT T1 at the level needed to create a constant current to the OLED D1. As a result, the AMOLED display operates at all times (i.e., for the entire frame scan), avoiding the need for the very high instantaneous currents required for passive matrix operation. The TFT T2 samples the data on the data line 160, which is held as charge stored in the storage capacitor Cs. The voltage held on the storage capacitor Cs is applied to the gate of the second TFT T1. In response, TFT T1 drives current through the OLED D1 to a specific brightness depending on the value of the sampled and held data signal as stored in the storage capacitor Cs.

FIG. 2 illustrates a conventional gamma network used with an active matrix OLED display. The gamma network 104 is a circuit that converts the brightness data for a sub-pixel from a digital number (DN) representing the desired gray level (brightness) to an analog voltage, which will produce the right amount of current to drive OLED D1 to emit the desired brightness when the analog voltage 160 is applied to the gate of TFT T1 in the sub-pixel 120 (See FIG. 1). For example, the gamma network 104 in FIG. 2 is a conventional 8 bit gamma network used with DN (8 bits) ranging from 0 to 255. Gamma network 104 includes a counter 202, a shift register (SRI) 204, a series of resistors (R0, . . . , R30, . . . R191, . . . , R223, . . . , R253, R254) (255 resistors for an 8 bit system) and 256 switches GT0, GT1, . . . , GT255. The gate of each switch GT0, GT1, . . . , GT255 is coupled to the corresponding one of the bits of shift register 204. When the corresponding binary bit at the shift register 204 is “1” the corresponding switch (GT0, GT1, . . . , GT255) is turned on, and when the binary bit at the shift register 204 is “0” the corresponding switch (GT0, GT1, . . . , GT255) is turned off. DN 101 can be any value between 0 and 255 for an eight bit system. Counter 202 counts up to the value of DN 101 sent to the Gamma network 104, causing shift register 204 to move its output to the gate of the gamma table switches GT(DN). For example, if a DN of 185 indicating brightness level 185 was sent to counter 202, shift register 204 would move its output to GT 185, thereby switching switch GT185 on. Gamma network 104 is essentially a voltage divider with 256 taps corresponding to 256 gray levels (brightnesses). The voltage at tap 185 is controlled by switch GT 185, which when turned on delivers to the gate of the TFT T1 in the specified sup-pixel the voltage calculated to produce a gray level brightness corresponding to DN 185.

The voltage 102 output from the gamma network 104 is designed to produce a series of currents from TFT T1 that will produce 256 levels (in an 8 bit display system) of light emission from OLED D1 conforming to the brightness response of the human eye. The human eye has a linear response approximate to the square root of brightness. That is, for the human eye to experience a doubling of brightness, the light flux has to be increased approximately 4 times. This relationship of eye response to light flux (brightness) is known as the gamma function (γ), which is not exactly 2 but closer to 2.2. In general, gamma gives contrast to the image. If, for example, gamma is reduced to 1 (a linear relationship between eye response and light), the images produced would have very low contrast, and be flat and very uninteresting. If gamma is increased, contrast of the image increases. Note that gamma refers to the relationship between the eye and light—not current or voltages. OLED emission is produced by current flowing through OLED D1 as controlled by TFT T1. Thus, it is the function of the gamma network 104 to produce an appropriate voltage, which will produce appropriate current through OLED D1, which will produce light with the correct (or desired) gamma function. The emission of light from OLED material is linear to the current. That is, in order to double the luminance (expressed as cd/m²—candelas per meter squared), current is doubled.

The brightness values in an image are represented as digital numbers (DNs). For an 8-bit display system, DNs range from 0 to 255. The light values are called gray scale levels and are linear to the human eye. Thus, a doubling of DNs is perceived by the human eye as a doubling of brightness. The gamma relation between DNs and the current of TFT T1 can be determined as follows. FIG. 3A illustrates the gamma curve showing the relationship between the digital number (DN) and the OLED current. Note that gamma curve 300 is not linear but has a curve with a changing slope. The exact shape of the gamma curve 300 is determined by the desired gamma. The gamma curve 300 shown in FIG. 3A is for a gamma of 2.

FIG. 3B is a table showing example resistors, voltages and currents for the gamma network in FIG. 2. Referring to FIGS. 2 and 3B, note that the resistors (R0 through R254) are grouped with roughly 32 resistors per group, except Group 0 that includes no resistor, although all the resistors are not shown in FIG. 2 for simplicity of illustration. Each resistor group (Group 0 through Group 8) is associated with a tap voltage Vtap0 through Vtap7 and Vgamma. The tap voltages, for example, are bounded by a minimum voltage (1.541 volts) and a maximum voltage (Vgamma, 12.000 volts). The tap voltages coupled with the minimum and maximum voltages establish the gamma current curve 300 with the aid of resistors R0 through R254. The tap voltages are voltage sources, and thus the voltage established between each resistor is determined by the current drawn between the tap voltages. The greater the number of tap voltages, the better current conformation is to the gamma curve. In the example of FIG. 3B, nine voltage sources produce the voltages at each resistor (R0 through R254), which in turn use TFT T1 to produce the current that conforms to the gamma curve 300. By adjusting the tap voltages, the gamma current curve 300 will change.

The gate voltage 102 to the TFT T1 is determined by the tap voltages, resistors, and which of the switches GT0, . . . , GT255 are turned on. For example, when DN is 255, counter 202 moves the output of shift register 204 to the gate line for GT255; thereby connecting Vgamma voltage to line 102 which connects to the column driver of the selected sub-pixel. Since the Vgamma voltage is the maximum voltage put out by the Gamma Network 104, the maximum voltage is placed on the gate of T1 in the selected sub-pixel. This maximum voltage causes TFT T1 in the selected sub-pixel to supply the current to OLED D1 for the brightest gray level for the sub-pixel. The voltage value of Vgamma is determined by the design of T1 and the designed top brightness of the sub-pixel. The methods of doing such design work are well known in the display industry. The table in FIG. 3B is an example of design voltages for Vgamma and the taps on the voltage divider. For example, the design voltage for Vgamma from FIG. 3B is 12 V. As a further example, if the sub-pixel is scheduled by the image data to be black (off) then DN 0 is sent to the gamma network 104 causing counter 202 to move the output of shift register 204 to switch GT0 connecting Vtap0 to the output line 102. The voltage value of Vtap0 from the table in FIG. 3B is 1.541 Volts, which when supplied to the gate of T1 through the column driver for the selected sub-pixel causes the current supplied to OLED D1 to be less than the threshold current for OLED D1 and therefore, no light will be emitted from the sub-pixel for the frame. The taps on the gamma network voltage divider 104 will be between Vgamma and Vtap0 (12 Volts and 1.541 Volts, respectively, in the example). As a further example, if DN 227 is sent to gamma network 104, counter 202 will move the output of shift register 204 to the gate line for switch GT227 connecting to the aforesaid voltage divider 104 at a point between Vgamma and Vtap7. The exact voltage connected through switch GT227 to output line 102, and thus, to the gate of TFT T1 in the selected sub-pixel will be determined by the voltage drop from Vgamma to Vtap7, which from the table in FIG. 3B is determined to be 12 Volts−10.729 Volts=1.271 Volts. There are 31 resistors (255−224=31) between Vgamma and Vtap7; therefore, the voltage is dropped in 31 equal decrements from Vgamma to Vtap, because all 31 resistors are of the same value, which from the FIG. 3B is 7843 Ohms each. Each voltage drop, therefore, is 1.271/31=0.041 volts. There are 28 resistors (255−227) between the GT227 tap and the GT255 tap; therefore, the voltage drop is 28×0.041=1.148 Volts. The exact voltage sent to the selected sub-pixel through output line 102 and the column driver to the gate of TFT T1 is 12 volts−1.148 Volts=10.852 Volts, which is the T1 gate voltage designed to supply the required current to OLED D1 to emit brightness corresponding to gray level 227. The other voltages at the various gray levels are calculated in the same manner.

Referring back to FIG. 1, the OLED display 100 requires regulated current in each sub-pixel to produce a desired brightness from the pixel. Ideally, the TFTs T1 in each sub-pixel 120 should be good current sources that deliver the same current for the same gate voltage over the lifetime of the OLED display. Also each current source TFT T1 in the active TFT matrix must deliver the same current for the same data voltage stored in the storage capacitor Cs in order that the display is uniform.

Note that there are two types of thin film semiconductors in popular use in the active matrix display industry: amorphous silicon (a-Si) and poly-silicon (p-Si). Emissive displays, such as the active matrix OLED (AMOLED) displays, require high current and stability not available in the a-Si TFTs and therefore typically use p-Si for the TFTs T1, T2. a-Si is converted to p-Si by laser annealing the a-Si to increase the crystal grain size and thus convert a-Si to p-Si. The larger the crystal grain size, the faster and more stable is the resulting semiconductor material. Unfortunately the grain size produced in the laser anneal step is not uniform due to a temperature spread in the laser beam. Thus, uniform TFTs T1, T2 are very difficult to produce and thus the current supplied by TFTs T1 in conventional OLED displays is often non-uniform, resulting in non-uniform display brightness. Non-uniform TFTs T1 throughout the OLED display causes “Mura” or streaking in the OLED displays made with p-Si TFTs. In other words, TFTs T1 may produce different OLED current due to its non-uniformities from sub-pixel to sub-pixel, even if the same gate voltage is applied to the TFTs T1. Therefore, it is necessary to compensate for non-uniformities in the TFTs T1 by applying corrected (compensated) T1 gate voltages that are different from the intended gate voltage from the graphics board (not shown) to the TFTs T1. This can be done by measuring the gray level (gate voltage) versus current characteristics of the TFTs T1 for each sub-pixel, and using such current measurement data to compensate for the non-uniformities in TFTs T1 when driving the TFTs T1 with the gate voltage 102 through the gamma network 104.

However, it is difficult to accurately measure the sub-pixel current of an OLED panel due to “panel dark current” also referred to as “dark current” or “background current” present in OLED displays driven by conventional OLED drivers. As shown in FIGS. 2 and 3B, conventional gamma networks 104 are configured such that at gray level 0, the tap voltage Vtap0 is a non-zero voltage (e.g., 1.541 volt in FIG. 3B) and the OLED sub-pixel current is non-zero (1.526E-11 A in the example of FIG. 3B). In other words, conventional gamma networks 104 are configured such that gray level 0 corresponds to the threshold OLED D1 current (1.526E-11 A in the example of FIG. 3B) below which light emission does not occur in the OLED D1. Conventional gamma networks 104 are configured in such manner because OLED D1 current does not start flowing until the T1 gate voltage reaches its threshold voltage Vt and until the current generated by TFT T1 reaches the threshold current of OLED D1. In order for the sub-pixel current to confirm to the desired gamma, thus the lowest tap voltage Vtap0 and the OLED sub-pixel current should be non-zero.

As a result, low current (under the threshold current of OLED D1) can flow through OLED D1 without light emission when the lowest tap voltage Vtap0 is applied as the T1 gate voltage 102. In other words, using conventional gamma network 104, when gray level 0 is applied to the sub-pixel, there is no light emission but there is still a low current, 1.526E−11 A in the example of FIG. 3B. This current forms part of the “panel dark current” referred to herein. “Panel dark current” or “dark current” or “background current” herein refers to the total OLED sub-pixel current in the OLED display from sub-pixels that are assigned gray level zero to be turned off (and the OLEDs do not emit any light). Such panel dark current may be quite significant. For example, for a quarter VGA OLED display commonly used in small portable electronic devices such as cellular telephones or personal digital assistants, there are 230,400 sub-pixels and the total gray level zero current may be approximately 3.52 μA (=1.526E-11 A 230,400).

Panel dark current adds significant noise while measuring the OLED sub-pixel current to correct non-uniformities in the OLED display For example, if a current measurement is made at eight points of a 256 gray level OLED display, the first gray level for current measurement is DN 32, which has an expected current of approximately 16 nA. To measure this small current 16 nA against a much larger background panel dark current of 3.52 μA is very difficult and adds substantial noise to the current measurement.

### SUMMARY OF THE INVENTION

Embodiments of the present invention include shutting off the current drivers of an emissive display device such as an OLED display to have minimum drain current when sub-pixel current is measured, in order to minimize dark current (background noise) during sub-pixel current measurement. The current drivers in the sub-pixels not under test are biased in such a manner as to reduce their leakage current to a minimum.

More specifically, in one embodiment, an emissive display device comprises a plurality of emissive display elements arranged in a plurality of rows and a plurality of columns, each of the emissive display elements corresponding to a subpixel of the emissive display device, and an active matrix drive circuit configured to drive current through the emissive display elements. The active matrix drive circuit includes a gamma network receiving gray level data and generating drive voltages corresponding to the gray level data to be applied to a drive transistor of a selected emissive display element to drive current through the selected emissive display element. At least one of the drive voltages generated by the gamma network causes the drive transistor to be shut off with minimum drain current.

According to the present invention, the panel dark current is minimized by shutting off the drive transistors that are associated with non-selected emissive display elements while current through a selected emissive display element is measured. Therefore, the signal to noise ratio between panel dark current (noise) and the OLED sub-pixel current (signal) can be maximized.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

The teachings of the embodiments of the present invention can be readily understood by considering the following detailed description in conjunction with the accompanying drawings.

FIG. 1 illustrates a conventional active matrix OLED display.

FIG. 2 illustrates a conventional gamma network used with an active matrix OLED display.

FIG. 3A illustrates a gamma curve showing the relationship between the digital number (DN) and the OLED current.

FIG. 3B is a table showing example resistors, voltages and currents for the gamma network in FIG. 2.

FIG. 4 illustrates an active matrix OLED display, according to one embodiment of the present invention.

FIG. 5A illustrates a modified gamma network used with an active matrix OLED display, according to one embodiment of the present invention.

FIG. 5B illustrates a modified gamma network used with an active matrix OLED display, according to another embodiment of the present invention.

FIG. 6 illustrates a method of measuring sub-pixel current in an OLED display, according to one embodiment of the present invention.

FIG. 7 illustrates transfer characteristics of n-channel and p-channel polysilicon TFTs.

### DETAILED DESCRIPTION OF EMBODIMENTS

The Figures (FIG.) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made in detail to several embodiments of the present invention(s), examples of which are illustrated in the accompanying figures. It is noted that wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

At a high level, a gamma network used in the OLED display is modified such that the panel dark current caused by leakage in the drive TFTs T1 is reduced, thereby minimizing background noise during sub-pixel current measurement.

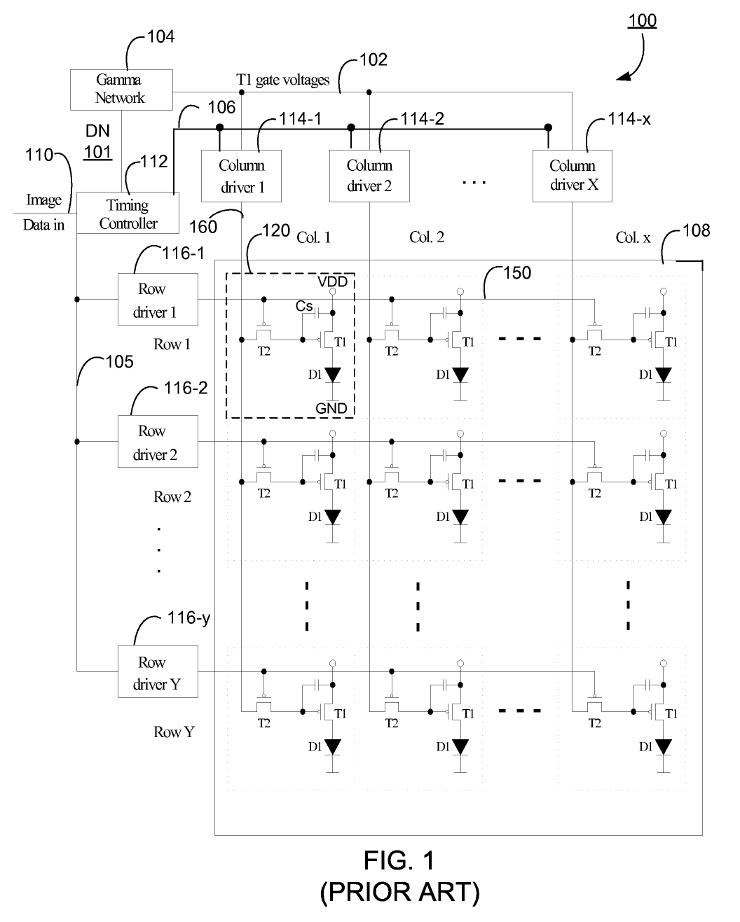

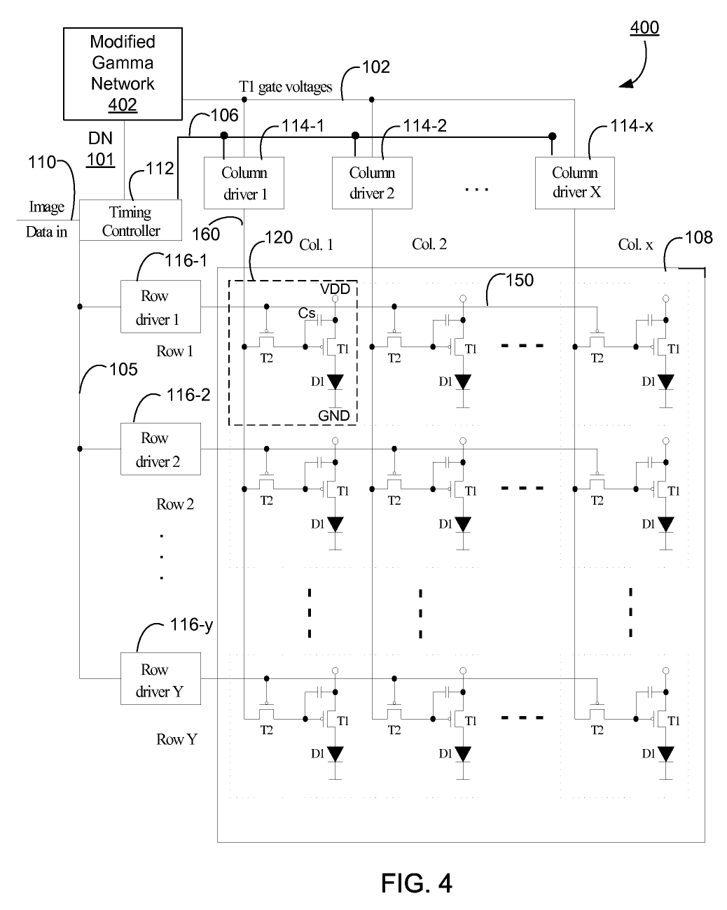

FIG. 4 illustrates an active matrix OLED display, according to one embodiment of the present invention. The AMOLED display 400 of FIG. 4 is substantially the same as the AMOLED display 100 of FIG. 1, except that a modified gamma network 402 is used to convert the gray level DNs 101 to T1 gate voltages 102.

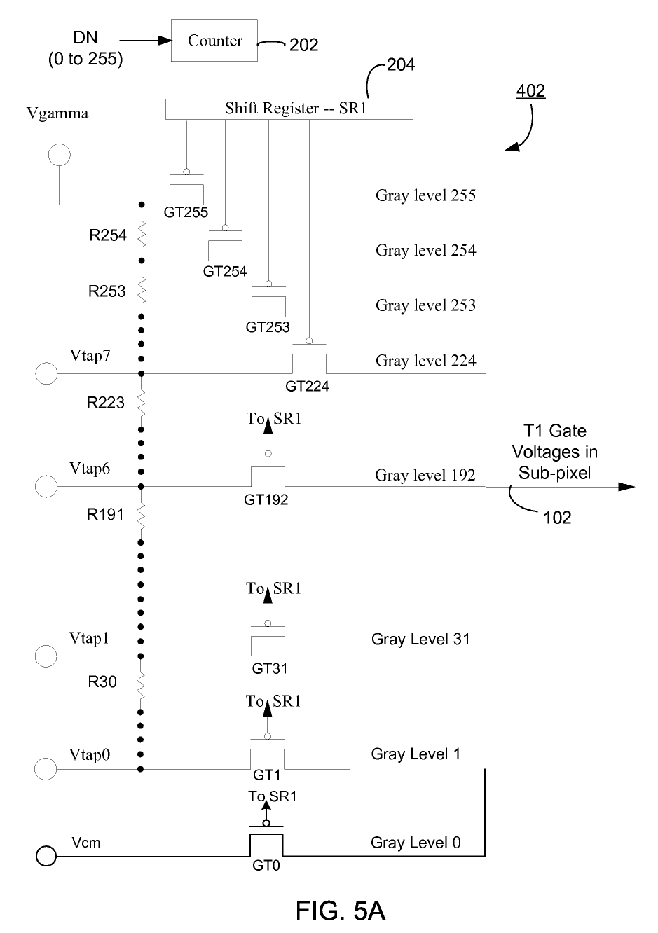

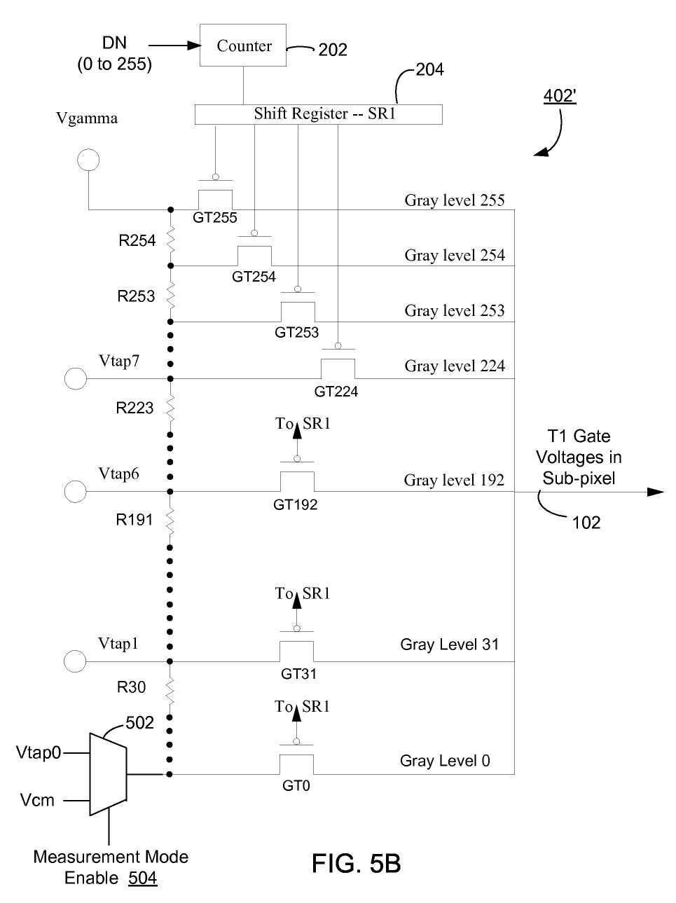

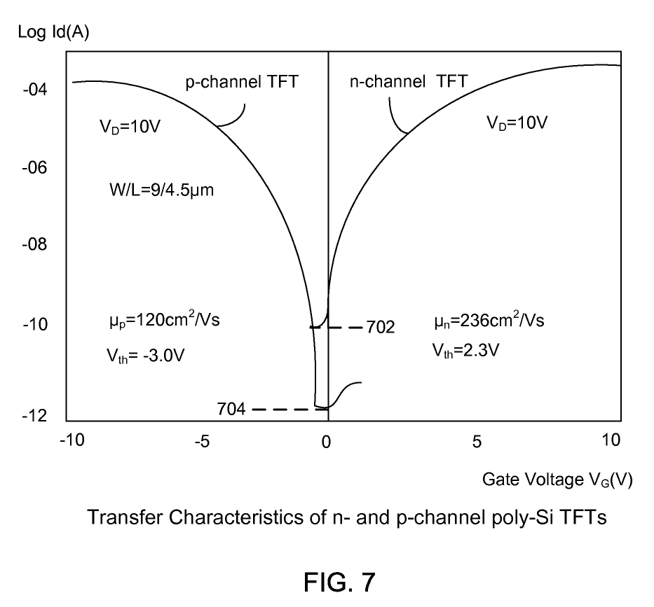

FIG. 5A illustrates the modified gamma network used with an active matrix OLED display, according to one embodiment of the present invention. In order to reduce the panel dark current in the OLED display, the drive TFTs T1 (FIG. 1) are shut off by reducing the gate voltage applied to the TFTs T1. To this end, the gate to source voltage of the TFT T1 must be zero or negative. FIG. 7 illustrates transfer characteristics of n-channel and p-channel polysilicon TFTs. For example, the n-channel TFT in FIG. 7 is for one that has an effective electron mobility (μₙ) of 236 cm²/Vs (source voltage), a drain voltage Vd of 10 volt, a threshold voltage Vth of 2.3 volt, and a width/length (W/L) ratio of 9/4.5 μm. The p-channel TFT in FIG. 7 is for one that has an effective hole mobility (μₚ) of 120 cm²/Vs (source voltage), a drain voltage Vd of 10 volt, a threshold voltage Vth of −3.0 volt, and a width/length (W/L) ratio of 9/4.5 μm. As shown in FIG. 7, the drain current (Id, represented in its logarithm Log Id (A)) for an n-channel TFT is minimum 702 when the gate voltage V_{G} relative to the source is a negative voltage, less than zero volts. In addition, the drain current (Id, represented in its logarithm Log Id (A)) for a p-channel TFT is minimum 704 when the gate voltage V_{G} relative to the source is approximately zero volt for a p-channel TFT. In other words, if the TFTs T1 are n-channel TFTs, this means that the gate voltage applied to the TFTs T1 with respect to ground should be zero or negative to generate minimum drain current 702 in the n-channel TFT T1. If the TFTs T1 are p-channel TFTs, the polarities for the source, drain, and gate are reversed. For example, in the example of FIG. 4, the T1 electrode connected to Vdd is the source. Thus, in case of a p-channel TFT T1, the gate voltage applied to the TFTs T1 should be equal to Vdd to obtain a gate to source voltage of approximately zero volts and generate minimum drain current 704 in the p-channel TFT T1.

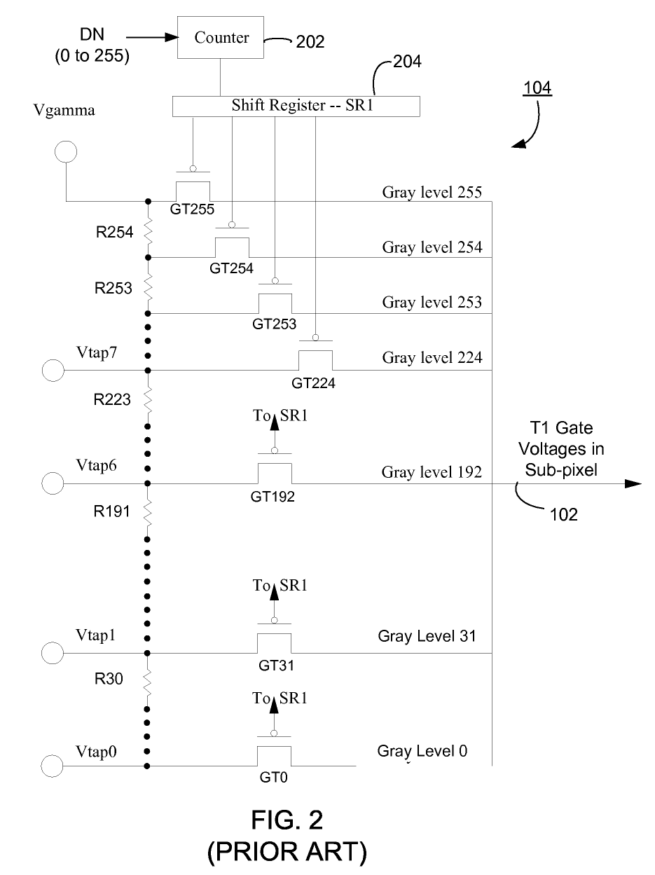

In the embodiment of FIG. 5A, the gamma network 402 is substantially the same as the gamma network 104 shown in FIG. 2, with the difference being that (i) an extra voltage tap Vcm is added to the gamma resistor network 402, coupled to switch GT0 corresponding to gray level DN=0, and (ii) Vtap0 is connected to switch GT1 corresponding to gray level DN=1. There is no resistor connected between tap voltages Vtap0 and Vcm. Vcm is zero volt or a negative voltage, and switch GT0 is turned on when the applied gray level DN is 0 such that such Vcm is provided as the T1 gate drive voltage 102 at gray level 0. Thus, there are 29 gray levels (corresponding to switches GT1 through GT30) between tap voltages Vtap0 and Vtap1 in the gamma network 402, which is one less gray level than the 30 gray levels available level between tap voltages Vtap0 and Vtap1 in the conventional gamma network 104. Since Vcm is zero volt or a negative voltage, the T1 gate voltage 102 is zero volt or a negative voltage when the gray level DN is zero, causing hard turn-off of drive TFT T1. In turn, this causes the TFT T1 and OLED D1 to have minimal leakage current, and significantly reduces the panel dark current when the sub-pixels are turned off.

The gamma network 402 of FIG. 5A has the advantage that the OLED display will display maximum black in response to DN=0 gray level. The gamma network 402 of FIG. 5A also has the advantage that no change in the tap voltages applied to the gamma network 402 is necessary during current measurement mode, because whenever gray level DN=0 is sent to the gamma network 402, the hard off voltage Vcm is sent to drive TFT T1 regardless of whether the display is in image rendering mode or in current measurement mode.

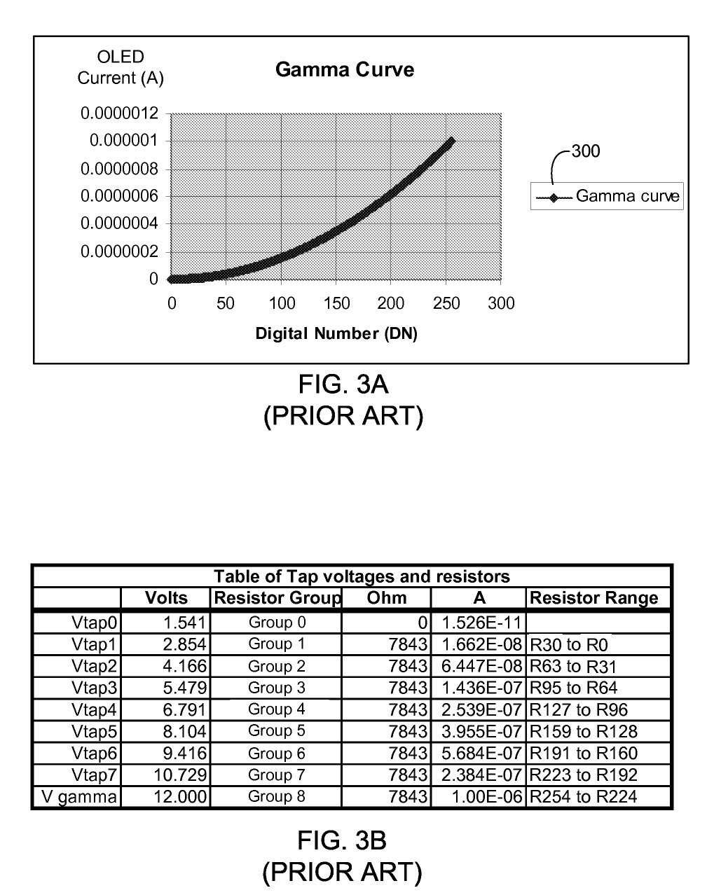

FIG. 5B illustrates a modified gamma network used with an active matrix OLED display, according to another embodiment of the present invention. In the embodiment of FIG. 5B, gamma network 402′ is substantially the same as the gamma network 104 shown in FIG. 2, with the difference being that multiplexer 502 is added and coupled to switch GT0 corresponding to gray level DN=0, with the multiplexer 502 configured to select one of two input voltages, Vtap0 and Vcm, in response to a measurement mode enable signal 504. Vcm is zero volt or a negative voltage, and Vtap0 is the same voltage as Vtap0 in FIG. 2 (e.g., 1.541 volts in FIG. 3B).

In normal operation, measurement mode enable signal 504 is, for example, “0” and causes multiplexer 502 to select the regular tap voltage Vtap0 to be coupled to switch GT0. Thus, in normal operation, the gamma network 402′ is the same as the conventional gamma network 104 of FIG. 2, and tap voltage Vtap0 is output as the T1 gate voltage 102 for gray level 0 in normal operation. However, in current measurement mode, measurement mode enable signal 504 is, for example, “1” and causes multiplexer 502 to select Vcm to be coupled to switch GT0. As a result, Vcm is output as the T1 gate voltage 102 for gray level 0. Since Vcm is zero volt or a negative voltage, the T1 gate voltage 102 is zero volt or a negative voltage when the gray level DN is zero in current measurement mode, causing hard-off of the drive TFTs T1. In turn, this causes the TFT T1 and OLED D1 of the sub-pixel 120 to have minimal leakage current, and thus significantly reduces the panel dark current when the sub-pixels are turned off.

The gamma network 402′ of FIG. 5A has the advantage that the tap voltage Vtap0 does not entirely shut off the OLED sub-pixels during normal operation, so that the first 32 gray levels of the OLED display better conform to the desired gamma curve. On the other hand, Vcm entirely shuts off the OLED sub-pixels in current measurement mode, thereby significantly reducing the panel dark current in current measurement mode.

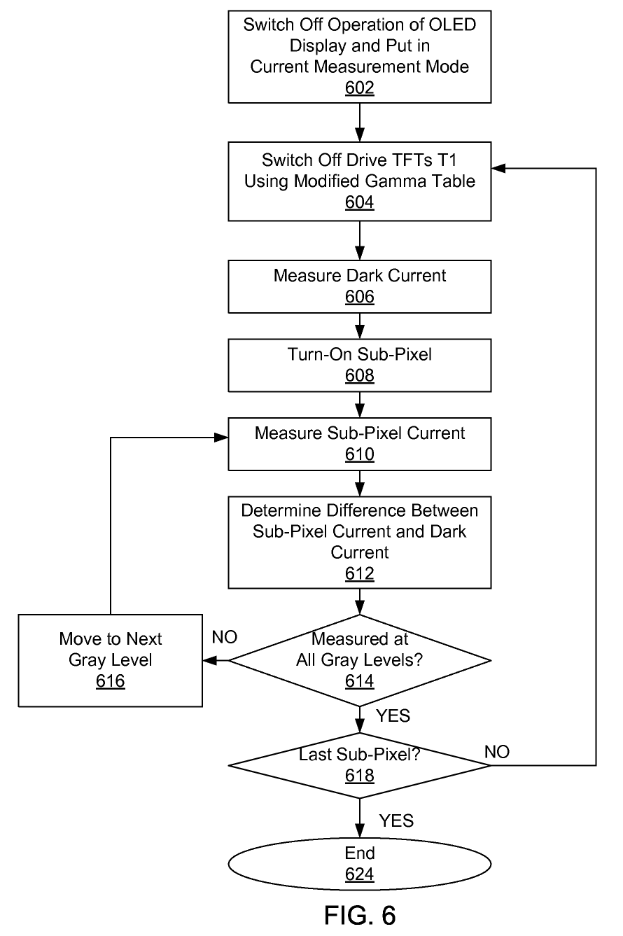

FIG. 6 illustrates a method of measuring sub-pixel current in an OLED display, according to one embodiment of the present invention. The method of FIG. 6 is explained with reference to FIG. 5A and FIG. 5B, and can be used with either one of the embodiments of FIG. 5A and FIG. 5B.

First, in step 602 the operation of the OLED display is switched off and put in current measurement mode. Normal operation of the OLED display is switched off in order to prevent noise caused by downloading of image data to the sub-pixels of the OLED display. In normal operation, the OLED display receives image data a row at a time. The row of image data in the form of varying TFT T1 gate drive voltages 102 is downloaded into a row of pixels in the row address time, and the active matrix circuit samples and holds this data voltage on the gates of the drive TFTs T1. Such downloading of image data continues row after row, until all rows in the OLED display have the image data downloaded. The time it takes for image data to be downloaded to all rows of the OLED display is one frame. Once a frame has been loaded, the next frame begins to load from the top row again. Typically, frames are supplied to the OLED display 60 times a second (60 frames/second), but can be supplied at other frame rates as well. In order to supply frames at 60 frames/second in a 320 row display, image data are written to the rows 19,200 times a second. This generates a high level of digital processing noise which would interfere with making sensitive current or voltage measurements of the pixels in the OLED display. Shutting off normal operation of the OLED display in step 602 would quiet the OLED display and allow current measurement devices (not shown in herein) to be connected to Vdd or Vss.

Next, in step 604 the drive TFTs T1 in the OLED display are switched off, by applying the zero volt or negative voltage Vcm as their gate voltages 102. This is done by applying gray level DN=0 to all the sub-pixels of the OLED display and switching the drive TFTs T1 hard off by applying the zero volt or negative voltage Vcm as their gate voltages 102, using the gamma network 402 of FIG. 5A or gamma network 402′ of FIG. 5B. Then, in step 606 the panel dark current to the OLED display is measured with gray level DN=0 applied to all the sub-pixels of the OLED display.

In step 608, the first sub-pixel to be tested is turned on at a first gray level. And, in step 610 the total current through the turned-on sub-pixel is measured. At this time, the drive TFTs T1 of the sub-pixels not under test (i.e., not selected in step 608) still remain shut off per step 604. One way of measuring the sub-pixel current of an OLED display is taught in U.S. patent application Ser. No. 11/710,462, filed by Walter Edward Naugler, Jr., et al. on Feb. 22, 2007 and entitled “Method and Apparatus for Managing and Uniformly Maintaining Pixel Circuitry in a Flat Panel Display,” which is incorporated by reference herein. Another way of measuring sub-pixel current of an OLED display is taught in U.S. patent application Ser. No. 12/018,455 filed by Walter Edward Naugler, Jr., et al. on Jan. 23, 2008 and entitled “Sub-Pixel Current Measurement for OLED Display,” which is incorporated by reference herein. However, note that other conventional methods of measuring the sub-pixel current of an OLED display may be used with embodiments of the present invention.

As shown in U.S. patent application Ser. No. 12/018,455, for example, the sub-pixel current is measured at a node where the current (if any) from the OLEDs from all sub-pixels of the OLED display are combined. Thus, the sub-pixel current measured in step 608 would include not only the actual current flowing through the selected OLED sub-pixel but also the panel dark current. Thus, in step 612, the difference between the total current measured in step 610 and the panel dark current measured in step 606 is determined, to obtain the actual OLED D1 current in the measured sub-pixel for the first gray level. Since the dark current is minimized by way of the gamma network according to various embodiments of the present invention, the sub-pixel current determined in step 612 is meaningful data.

Then, in step 614 it is determined whether the OLED current is measured at all gray levels to be measured for the first sub-pixel. This may be just a few gray levels spaced apart or all the gray levels of the OLED display, depending on the desired accuracy of the current measurement. If the OLED current was not measured at all gray levels for the first sub-pixel, the process moves to the next gray level in step 616 and steps 610, 612, 614 are repeated for the remaining gray levels. If the OLED current was measured at all gray levels for the first sub-pixel, then in step 618 it is determined whether the measured sub-pixel is the last pixel of the OLED display. If the measured sub-pixel is not the last sub-pixel, the process returns to step 604 to repeat steps 604, 606, 608, 610, 612, 614, and 616 for the remaining sub-pixels of the OLED display. If the measured sub-pixel is the last sub-pixel, the process ends 624 and the DN versus sub-pixel OLED current curve is obtained for the sub-pixels of the OLED display.

The method of OLED sub-pixel current measurement according to the present invention has the advantage that the panel dark current is minimized by use of a hard shut off voltage 102 applied to the gate of drive TFT T1 for gray level 0. Therefore, the signal to noise ratio between panel dark current (noise) and the OLED sub-pixel current (signal) can be maximized.

Upon reading this disclosure, those of skill in the art will appreciate still additional alternative structural and functional designs for minimizing panel dark current in an OLED display in order to obtain accurate measurement of sub-pixel current. Thus, while particular embodiments and applications of the present invention have been illustrated and described, it is to be understood that the invention is not limited to the precise construction and components disclosed herein and that various modifications, changes and variations which will be apparent to those skilled in the art may be made in the arrangement, operation and details of the method and apparatus of the present invention disclosed herein without departing from the spirit and scope of the invention as defined in the appended claims.

What is claimed is:

1. An emissive display device comprising:
a plurality of emissive display elements arranged in a plurality of rows and a plurality of columns, each of the emissive display elements corresponding to a subpixel of the emissive display device; and
an active matrix drive circuit configured to drive current through the emissive display elements, the active matrix drive circuit including a gamma network receiving gray level data and generating drive voltages corresponding to the gray level data to be applied to a drive transistor of a selected emissive display element to drive current through the selected emissive display element, at least one of the drive voltages generated by the gamma network causing the drive transistor to be shut off with minimum drain current.

2. The emissive display device of claim 1, wherein the gamma network generates said one of the drive voltages causing the drive transistor to be shut off responsive to zero gray level.

3. The emissive display device of claim 1, wherein the drive transistor is an n-type thin film transistor and the gamma network generates said one of the drive voltages to be zero volt or a negative voltage applied to a gate of the n-type thin film transistor.

4. The emissive display device of claim 3, wherein the gamma network comprises:
a voltage divider coupled to and dividing a plurality of tap voltages to generate a plurality of drive voltages based on the tap voltages;
a plurality of switches each coupled to a corresponding one of the drive voltages and each coupling the corresponding one of the drive voltages to the drive transistor when said each of the switches is turned on; and
at least another switch coupled to another drive voltage causing the drive transistor to be shut off.

5. The emissive display device of claim 4, wherein the drive transistor is an n-type thin film transistor and said another drive voltage is zero volt or a negative voltage.

6. The emissive display device of claim 4, wherein said at least another switch is coupled directly to said another drive voltage and is not coupled to receive any one of the plurality of drive voltages generated by the voltage divider.

7. The emissive display device of claim 4, wherein the gamma network further comprises a multiplexer configured to select either said another drive voltage causing the drive transistor to be shut off in a first operation mode or one of the drive voltages generated by the voltage divider in a second operation mode, responsive to a mode selection signal.

8. The emissive display device of claim 7, wherein the mode selection signal causes the multiplexer to select said another drive voltage causing the drive transistor to be shut off in a current measurement mode of the selected emissive display element.

9. The emissive display device of claim 1, wherein the emissive display device is an active matrix organic light-emitting diode (AMOLED) display and the emissive display elements are organic light-emitting diodes (OLEDs).

10. A method of measuring current through an emissive display element of an emissive display device including a plurality of emissive display elements arranged in a plurality of rows and a plurality of columns, each of the emissive display elements corresponding to a subpixel of the emissive display device and current being driven through said each of the emissive display elements by a corresponding one of a plurality of drive transistors, the method comprising the steps of:
shutting off the drive transistors of the emissive display device, the drive transistors being with minimum drain current;
measuring a dark current of the emissive display device;
measuring a total current through a selected emissive display element with the drive transistors configured to drive the non-selected emissive display elements shut off; and
determining a difference between the total current and the dark current to obtain the current through the selected emissive display element.

11. The method of claim 10, wherein the step of shutting off the drive transistors comprises generating drive voltages causing the drive transistors to be shut off responsive to zero gray level, using a gamma network.

12. The method of claim 11, wherein the drive transistors are n-type thin film transistors and the drive voltages are zero volt or a negative voltage.

13. The method of claim 10, further comprising the step of turning off operation of the emissive display device and putting the emissive display device in current measurement mode prior to measuring the dark current and the total current.

14. The method of claim 10, wherein the steps of measuring the total current and determining the difference are repeated for a plurality of gray levels.

15. The method of claim 10, wherein the steps of shutting off the drive transistors, measuring the dark current, measuring the total current, and determining the difference are repeated for a plurality of sub-pixels of the emissive display device.

16. The method of claim 10, wherein the emissive display device is an active matrix organic light-emitting diode (AMOLED) display and the emissive display elements are organic light-emitting diodes (OLEDs).
